(19) United States
(12) Patent Application Publication
(10) Pub. No.: US 2011/0256428 A1
(43) Pub. Date: Oct. 20, 2011

(54) BATTERY PACK

(75) Inventors: PEI-JAN HO, TAIPEI CITY (TW); YU-WEN WU, MA KUNG CITY (TW); YU-KANG CHANG, HSIN CHU CITY (TW); NAN-CHUN WU, TAI NAN CITY (TW)

(73) Assignee: SIMPLO TECHNOLOGY CO., LTD., Hukou (TW)

(21) Appl. No.: 13/079,535

(22) Filed: Apr. 4, 2011

Related U.S. Application Data
(60) Provisional application No. 61/325,366, filed on Apr. 19, 2010.

(51) Int. Cl. H01M 10/42

(52) U.S. Cl. 429/7

(57) ABSTRACT

The present invention provides a battery pack which comprises a case for defining a space; a first and second cell boxes set inside the space for accepting battery cells; a first, second and third conductors for electrically connecting the electrodes of the battery cells set in the first and second cell boxes; a conductive layout formed on the inside surface of the case for electrically connecting the battery cells; and a circuit board disposed in the space and connected with the battery cells through the conductive layout and the first, second and third conductors. The first cell box, the second cell box, the circuit board and/or at least one of the battery cells is capable of being taken apart from the battery pack and replaced in a non-destructive way.

### BACKGROUND OF THE INVENTION

1. Field of the Invention

The present invention relates to a battery pack, especially to a battery pack that is easy to be assembled and/or disassembled.

2. Description of Related Art

Speaking of a portable rechargeable battery pack, the interconnection of its internal circuit is mostly achieved by lead wire. A well-known interconnection method comprises the steps of connecting the battery cells of each cell group of a battery pack through a nickel sheet, connecting a circuit board to a positive terminal of a first cell group with lead wire, connecting the circuit board to the nickel sheets of the first cell group and a second cell group with lead wire, connecting the circuit board to the nickel sheets of the second cell group and a third cell group with lead wire, and connecting the circuit board to the negative terminal of the third cell group with lead wire.

According to the above-mentioned prior art, the nickel sheets, the circuit board and the lead wire are connected by welding, so that each of the cell groups connects to the circuit board (e.g. a flexible composite substrate) to provide its power for it.

More specifically, the lead wire and battery cells connect to each other by resistance welding. The connected lead wire and battery cells are arranged in serial or parallel manner to form a plurality of cell groups. A wire covered with insulation material is then connected to each of the cell groups while the circuit board is soldered to the wire. Afterward, a casing of plastic material is used to encapsulate all of the cell groups and the circuit board, so as to finish the assembly process of the battery pack.

However, the welding process consumes a lot soldering tin and manpower and brings the disadvantages of environmental pollution and quality issues such as cold welding, missing welding, solder beading, solder dross, solder ball, and etc. Once said quality issues cause the problem of open circuit to any of the cell groups, the whole battery pack will no longer work; once said quality issues cause the problem of short circuit to any of the cell groups, the whole battery pack consequently carries safety issues. Therefore, a new design of battery pack without the aforementioned disadvantages is necessary.

### SUMMARY OF THE INVENTION

A purpose of the present invention is to provide a battery pack for improving the aforementioned prior art.

Another purpose of the present invention is to provide a battery pack easy to be assembled and/or disassembled.

According to an embodiment of the present invention, a battery pack comprises a case, a first cell box, a second cell box, a first conductor, a second conductor, a third conductor, a conductive layout and a circuit board. The case provides a space and includes a first cover and a second cover. The first cell box is disposed within the space and provides a plurality of first cell rooms, each of which is for placing a first battery cell. The second cell box is also disposed within the space and defines a plurality of second cell rooms, each of which is for placing a second battery cell. The first conductor electrically connects every negative electrode of the first battery cells in the first cell box. The second conductor electrically connects every positive electrode of the first battery cells in the first cell box and every negative electrode of the second battery cells in the second cell box. The third conductor electrically connects every positive electrode of the second battery cells in the second cell box.

The conductive layout is formed on the surface of the first or second cover for electrically connecting the first, second and third conductors, so as to realize the connection relation of the battery cells. The circuit board is placed inside the space and fixed to the first or second cover, so that the circuit board can electrically connect to the battery cells through the conductive layout and the first, second and third conductors.

Since the battery pack of the present invention is not only easy to be assembled but also easy to be disassembled, at least one of the first cell box, the second cell box, the circuit board and each of the battery cells can be taken apart from and/or reinstalled into the battery pack easily in a non-destructive way. To be more specific, the first and second cell boxes can be taken out from and/or reinstalled into the space of the case in a non-destructive way; the circuit board can be disparted from and/or reset on the first or second cover in a non-destructive way; and each of the battery cells can be replaced in a non-destructive way.

Regarding to the conductive layout, it can be fixed to the first or second cover in various manners such as using glue or adhesive tape. In an embodiment, the conductive layout is stuck to the first or second cover by gluing. In another embodiment, the conductive layout adheres to the first or second cover through adhesive tape.

According to another embodiment of the present invention, the battery pack further comprises a pin connector, so that the conductive layout connects to the circuit board through the pin connector. In an embodiment, the connector includes a conductive connection part such as a conductive elastic piece which has one portion connecting to the conductive layout of the first or second cover and another portion connecting to the circuit board.

As a result, the battery pack can be assembled and/or disassembled in a modular way. Consequently, the manpower needed for executing welding process can be reduced, the quality issues caused by artificial soldering operation can be decreased, and the production process can be simplified and carried out by introducing automatic assembly line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A˜1C illustrates the assembly of a battery pack according to an embodiment of the present invention.

FIG. 2A shows the bottom view of a battery set according to an embodiment of the present invention.

FIG. 2B shows the top view of a battery set according to an embodiment of the present invention.

FIG. 3 shows the explosion diagram of a battery pack according to an embodiment of the present invention.

FIG. 4 shows the detail view of a pin connector according to an embodiment of the present invention.

FIG. 5 illustrates the flow chart of a battery pack assembly process according to an embodiment of the present invention.

### DETAILED DESCRIPTION OF THE PREFERRED EMBODIMENTS

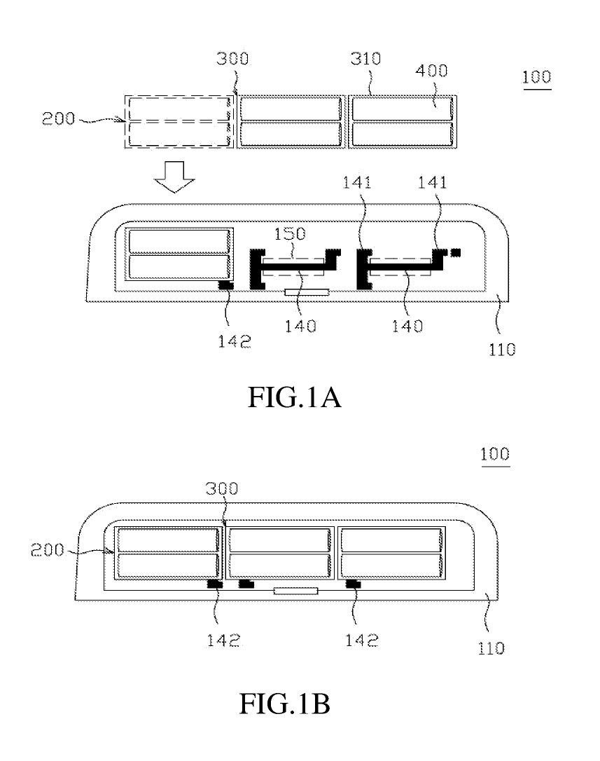

FIGS. 1A˜1C illustrates the assembly of a battery pack according to an embodiment of the present invention. As shown in FIGS. 1A˜1C, a battery pack 100 is designed in a modular way which comprises the features of placing a plurality of battery cells 400 in a cell box 310 to accomplish a battery set 300 as the basic unit of the modular design; positioning a plurality of said battery sets on a bottom cover 110, so that the plurality of battery sets connect to each other in series and/or parallel to constitute a battery set arrangement 200; positioning a circuit board 130 on the bottom cover 110 and having it connect to the battery set arrangement 200; and finally jointing an upper cover (not shown) with a bottom cover 110 to complete the assembly of the battery pack 100.

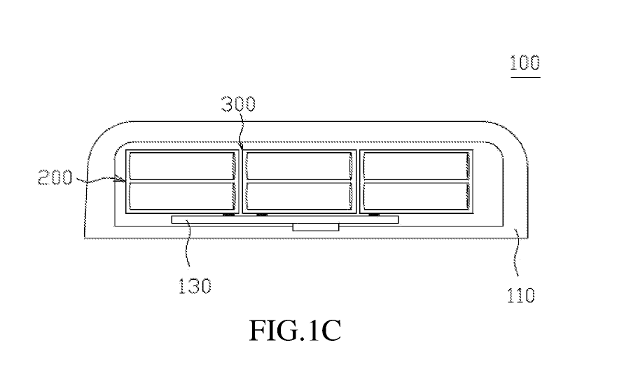

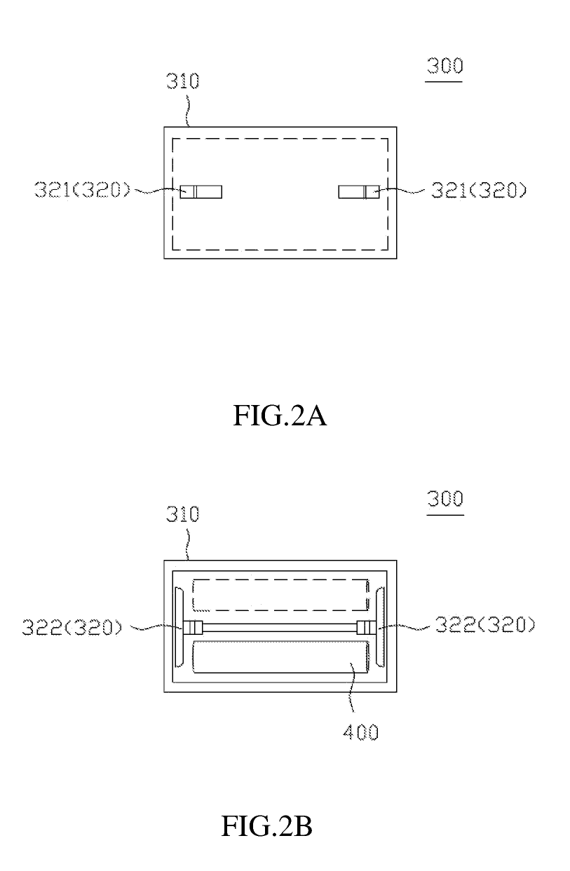

The following will go into detail on the structure of the battery pack 100. Please refer to FIGS. 2A and 2B which shows the bottom view and the top view of the battery set 300 respectively. As shown in FIGS. 2A and 2B, the battery set 300 comprises a cell box 310, a plurality of conductive sheets 320 and a plurality of battery cells 400. The plurality of conductive sheets 320 are disposed at the two sides of the cell box 310. Each conductive sheet 320 has a first portion 321 that stretches from the inside of the cell box 310 to its outside and a second portion 322 that is situated at a side of the interior of the cell box 310. In this embodiment, each first portion 321 goes through the bottom plate of the cell box 310 and bends to the back of the bottom plate; meanwhile, each second portion 322 is disposed at the interior side to contact the electrodes of the battery cells 400 in the cell box 310. Accordingly, if any of the battery cells 400 is damaged, the damaged battery cell 400 or the battery set 300 including it can be removed and replaced in a non-destructive way. By contrast, the whole battery pack should be replaced with a new one according to the prior art.

Please refer to FIG. 1A again. The bottom cover 110 has a plurality of metal strips 140 set on it. However, in another embodiment, the plurality of metal strips 140 are disposed on the upper cover (not shown) instead of the bottom cover. These metal strips 140 are in the shape of long strap and flexible for the layout of current path. The metal strip 140 may have a connection portion 141 which locates at a position corresponding to the position of the first portion 321 of FIG. 2A and electrically connects to it after the cell box 300 is set on the bottom cover 110. The metal strip 140 may further have a connection portion 142 for electrically connecting with the circuit board 130 after it is installed at the bottom cover 110. Please note that the metal strips 140 could be replaced by conductive strips of non-metallic material in another embodiment.

There are several methods to fix the metal strips 140 to the bottom cover 110. For example, the metal strips may be inlaid into a plurality of preset grooves (not shown) formed on the inside surface of the bottom cover 110 or stuck on the inside surface of the bottom cover 110. In an embodiment, the metal strips 140 are stuck on the inside surface of the bottom cover 110 by an insulation tape 150 such as an adhesive tape. The insulation tape may be pasted up on most of the inside surface of the bottom cover 110 except the connection portions 141 and 142, or stuck on it while a plurality of openings (not shown) are reserved. These openings are disposed at the positions corresponding to the first portion 321 of FIG. 2A and the connection portions 141 and 142, so that the first portion 321 and the circuit board 130 are able to contact the connection portions 141 and 142.

Based on the above-mentioned design of the present invention, the battery cell 400, the battery set 300, and/or the circuit board 130 of the battery pack 100 can be replaced easily in a non-destructive way. As to a conventional battery pack, once any of the battery cells installed in it is damaged, the whole battery pack should be replaced or the damaged cell could be replaced only through a destructive way such as the process of un-welding and then welding again which therefore induces safety issues. Comparing to the conventional design, the present invention allows the battery cell 400 to be set in the cell box 310 through any appropriate current non-welding method such as using baffles, troughs, fasteners and/or pushers to make up the battery set 300. Accordingly, if the battery pack 100 failed or malfunctioned because of any of its battery cells 400 failure, the damaged battery cell 400 or the battery set 300 including it can be replaced with a workable one in a non-destructive way.

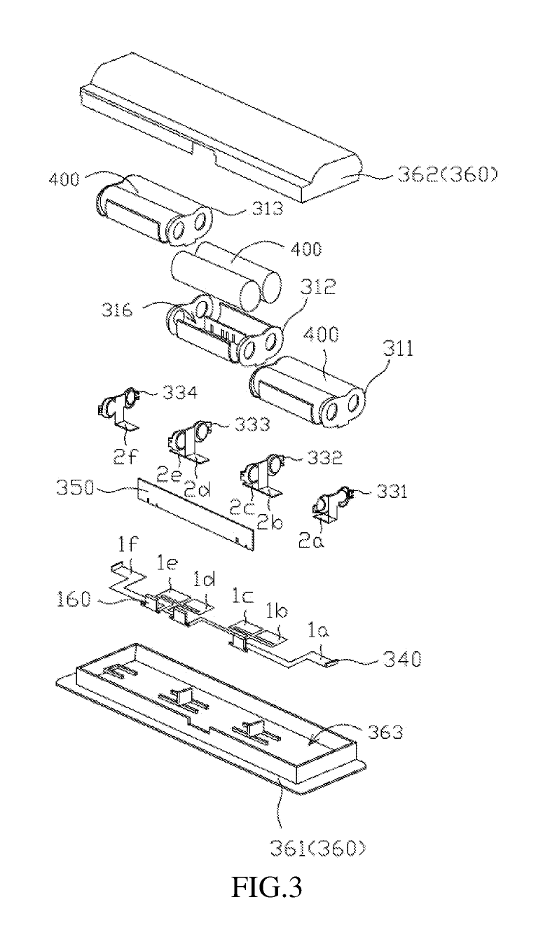

FIG. 3 shows the explosion diagram of a battery pack in accordance with an embodiment of the present invention. Most of the battery pack structure is the same as that of FIG. 1C and thus common components are marked with the same labels and reiterative description is omitted. As shown in FIG. 3, the battery pack 100 of the present invention comprises a case 360, a first cell box 311, a second cell box 312, a first conductor 331, a second conductor 332, a third conductor 333, a conductive layout 340 and a circuit board 350. In this embodiment, the battery pack 100 further comprises a third cell box 313 and a fourth conductor 334. An artisan of ordinary skill in the art will appreciate how to increase or decrease the number of cell box and conductor to fulfill the present invention based on the disclosure of this specification.

More specifically, the case 360 provides a space 363 and includes a first cover 361 and a second cover 362 which together define the space 363. The first cell box 311 is set inside the space and provides a plurality of first cell rooms 316 (i.e. the two cell rooms 316 as shown in FIG. 3). Each of the cell rooms 316 is for placing a battery cell 400. The second cell box 312 is also set inside the space 363 and provides a plurality of second cell rooms. Similarly, each of the second cell rooms is for placing a battery cell 400. Besides, the first conductor 331 electrically connects the negative electrode of every battery cell 400 in the cell box 311; the second conductor 332 electrically connects the positive electrode of every battery cell 400 in the first cell box 311 and the negative electrode of every battery cell 400 in the second cell box 312; the third conductor 333 electrically connects the positive electrode of every battery cell 400 in the second cell box 312 and the negative electrode of every battery cell 400 in the third cell box 313; and the fourth conductor 334 electrically connects the positive electrode of every battery cell 400 in the third cell box 313, wherein the first, second, third and fourth conductors 331˜334 could be any kind of conductive plate such as a copper plate.

The conductive layout 340 is formed on the inside surface of the first cover 361 for electrically connecting the first, second and third conductors 331, 332 and 333, so as to constitute the connection relation of the battery cells 400 in the first, second and third cell boxes 311˜313. To be more specific, the conductive layout 340 comprises a plurality of metal strips which have a plurality of connection portions 1a˜1f (equivalent to the connection portion 141 of FIG. 1A) disposed at the positions corresponding to the positions of the first portions 2a˜2f of the conductors 331˜334. The conductors 331˜334 are equivalent to the conductive sheets 320 and the first portions 2a˜2f are equivalent to the first portions 321 as shown in FIG. 2A. The first and second covers 361, 362 are in the form of long shape and used for protecting the components inside the battery pack 100. After the conductive layout 340 is formed on the first cover 361, the connection portions 1a and if contact the two terminals of the serial-connected cell boxes 311˜313, i.e. the conductors 331 and 334, to serve as negative and positive electrodes respectively when supplying power, and the connection portions 1b˜1e couple to the second and third conductors 332, 333 and a voltage detection device (not shown) to allow the voltage detection device detecting the voltages of the battery cells 400 in the cell boxes 311˜313. The conductive layout 340 further electrically connects to a pin connector 160 which contacts a connection pad of the circuit board 350.

The circuit board 350 is set inside the space 363 and fixed to the first cover 361 or the second cover 362, and connects to the battery cells 400 through the conductive layout 340 and the first, second and third conductors 331, 332, 333.

In this embodiment, the cell boxes 311˜313, the circuit board 350 and/or at least one of the battery cells 400 can be taken apart from and reinstalled into the battery pack 100 in a non-destructive way. The cell boxes 311˜313 can be installed in the space 363 through a non-welding method such as using baffles, troughs, fasteners and/or pushers, so that they can be disassembled without destroying anything. Similarly, the circuit board 350 can be set inside the space 363 by using baffles, troughs, fasteners and/or pushers and thereby can be replaced or removed gently. The battery cells 400 can be placed in the cell boxes 311˜313 through baffles, troughs, fasteners and/or pushers and therefore can be taken out without damaging the cell boxes 311˜313.

The circuit board 350 and the conductive layout 340 connect to each other through the pin connector 160, wherein the pin connector 160 and the conductive layout 340 are soldered together while the circuit board 350 is set to electrically contact the pin connector 160 in a non-welding method. More specifically, the connection pad of the circuit board 350 contacts an conductive elastic piece of the pin connector 160. After that, the second cover 362 is combined with the first cover 361 to complete the assembly of the battery pack 100.

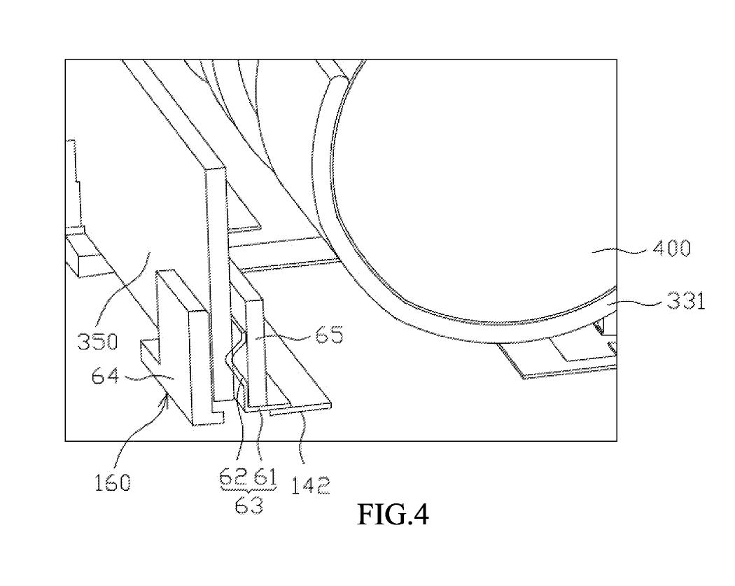

FIG. 4 shows the detail view of the pin connector 160. As shown in FIG. 4, the pin connector 160 comprises a conductive connection part 63 which has a portion 61 electrically connecting to the metal strip of the conductive layout 340 and another portion 62 electrically contacting the circuit board 350. To be more specific, the portion 61 connects to the connection part 142 of the metal strip by soldering while the portion 62 physically contacts the connection pad of the circuit board 350 by elastic force. In this embodiment, the pin connector 160 comprises a first baffle 64 and a second baffle 65 while the connection pad of the circuit board 350 and the portion 62 of the conductive connection part 63 are set between them. Actually, the connection pad of the circuit board 350 is set between the first baffle 64 and the portion 62. Moreover, the portions 61 and 62 of the conductive connection part 63 constitute an included angle such as an angle of 90 degree.

The portion 62 of the conductive connection part 63 may contact the circuit board 350 with various ways in different embodiments. In a preferred embodiment, the conductive connection part 63 is a conductive elastic piece, so that the portion 62 of it touches the connection pad of the circuit board 350 by mechanical force, e.g. elastic force.

Besides, the aforementioned first and second baffles 64, 65 are fixed to the bottom plate of the first cover 61 and stand on the bottom plate vertically or in a predetermined angle. The first and second baffles 64, 65 together define a slot, so that the circuit board 350 can be fixed to the first cover 361 through the slot. More specifically, at least a part of the circuit board 350 is inserted into the slot through resisting the elastic force of the portion 62 which consequently contacts and presses the connection pad of the circuit board 350 to maintain it stable.

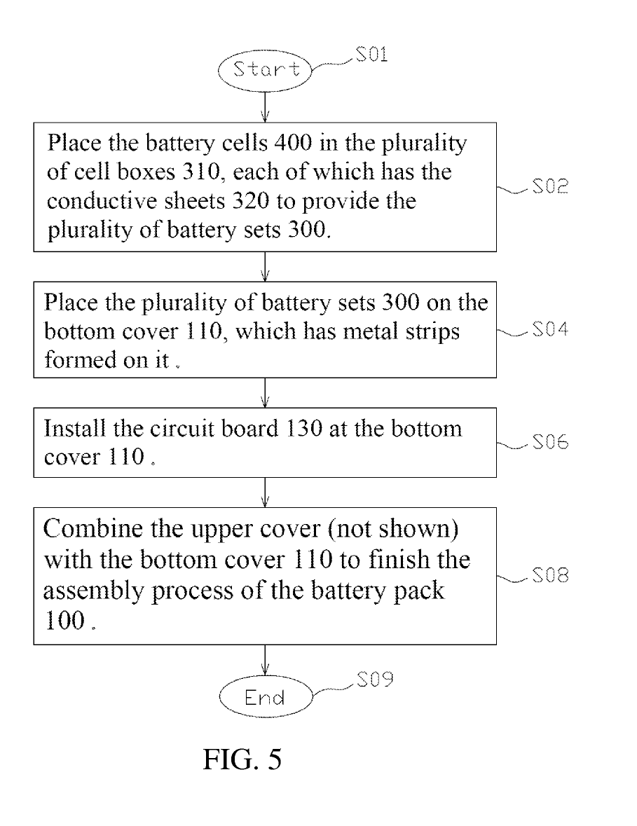

FIG. 5 illustrates the flow chart of a battery pack assembly process according to an embodiment of the present invention. Please refer to FIGS. 1A˜1C and FIG. 5. The battery pack assembly process comprises the following steps.

Step S02: Place the battery cells 400 in the plurality of cell boxes 310, each of which has the conductive sheets 320 set on it as shown in FIGS. 2A˜2B, by a manual manner, a mechanical gripper, mechanical vacuum absorption and/or magnetic absorption to provide the plurality of battery sets 300.

Step S04: Place the plurality of battery sets 300 on the bottom cover 110, which has metal strips formed on it, by a manual manner, a mechanical gripper, mechanical vacuum absorption and/or magnetic absorption.

Step S06: Install the circuit board 130 at the bottom cover 110 by a manual manner, mechanical gripper, mechanical vacuum absorption and/or magnetic absorption.

Step S08: Combine the upper cover (not shown) with the bottom cover 110 to finish the assembly process of the battery pack 100.

In another embodiment of the present invention, a single battery cell 400 is set in a cell box 310 to form a battery set 300. Then plural battery sets 300 are connected in series and/or parallel to accomplish a battery set arrangement 200. Furthermore, the cell box 310 may provide a plurality of cell rooms for accepting a plurality of battery cells 400 connected in parallel while the number of cell rooms is determined according to the demand of different product.

Besides, the number of serial-connected battery sets 300 is also determined by the demand of different product. The battery sets 300 are set on the bottom cover 110 which has metal strips 140 formed on it, so that these battery sets 300 can electrically connect to each other through the conductive sheets 320 of their cell boxes 310 and the metal strips 140 connected with the conductive sheets 320.

To sum up, the present invention provides new assembly of a battery pack and the assembly process thereof which have the advantages of saving soldering tin resource, reducing environmental pollution, lowing the demand of manpower, and decreasing man-made soldering quality issues. Furthermore, since the assembly and the process thereof are simplified, the production of the battery pack could be done by utilizing automatic assembly line to further decrease the manpower requirement.

Finally, please note that the aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A battery pack comprising:
a case providing a space and including a first cover and a second cover;
a first cell box set inside the space and including a plurality of first cell rooms, each of which is for placing a first battery cell;
a second cell box set inside the space and including a plurality of second cell rooms, each of which is for placing a second battery cell;
a first conductor for electrically connecting the negative electrode of each of the first battery cells in the first cell box;
a second conductor for electrically connecting the positive electrode of each of the first battery cells in the first cell box and the negative electrode of each of the second battery cells in the second cell box;
a third conductor for electrically connecting the positive electrode of each of the second battery cells in the second cell box;
a conductive layout set on the surface of the first or second cover and electrically connecting the first, second and third conductors; and
a circuit board set inside the space, fixed to the first or second cover and electrically connecting to each of the first and second battery cells through the conductive layout and the first, second and third conductors,
wherein at least one of the first cell box, the second cell box and the circuit board can be disassembled in a non-destructive way.

2. The battery pack of claim 1, wherein the conductive layout is fixed to the first or second cover.

3. The battery pack of claim 2, wherein the conductive layout is stuck on the first or second cover.

4. The battery pack of claim 3, wherein the conductive layout is stuck on the first or second cover by an insulation tape.

5. The battery pack of claim 1, further comprising a pin connector to electrically connect the conductive layout to the circuit board.

6. The battery pack of claim 5, wherein the pin connector comprises:
a conductive connection part having a first portion electrically connecting to the conductive layout and a second portion electrically connecting to the circuit board.

7. The battery pack of claim 6, wherein the conductive connection part is an conductive elastic piece and thereby the second portion of the conductive connection part contacts and presses the circuit board by elastic force to keep it stable.

8. A battery pack comprising:
a case providing a space and including a first cover and a second cover;
a first cell box set inside the space and including a plurality of first cell rooms, each of which is for placing a first battery cell;
a second cell box set inside the space and including a plurality of second cell rooms, each of which is for placing a second battery cell;
a first conductor for electrically connecting the negative electrode of each of the first battery cells in the first cell box;
a second conductor for electrically connecting the positive electrode of each of the first battery cells in the first cell box and the negative electrode of each of the second battery cells in the second cell box;
a third conductor for electrically connecting the positive electrode of each of the second battery cells in the second cell box;
a conductive layout formed on the surface of the first cover and electrically connecting the first, second and third conductors; and
a circuit board set inside the space, fixed to the first or second cover and electrically connecting to each of the first and second battery cells through the conductive layout and the first, second and third conductors,
wherein each of the first and second battery cells can be disassembled in a non-destructive way.

9. The battery pack of claim 8, further comprising a pin connector to electrically connect the conductive layout with the circuit board.

10. The battery pack of claim 9, wherein the pin connector includes an conductive elastic piece which contacts and presses the circuit board by elastic force to maintain it stable.
